(19) United States
(12) Patent Application Publication
(10) Pub. No.: US 2024/0303535 A1
(43) Pub. Date: Sep. 12, 2024

(54) SYSTEMS AND METHODS FOR MACHINE LEARNING MODEL MANAGEMENT

(71) Applicant: JPMORGAN CHASE BANK, N.A., New York, NY (US)

(72) Inventors: Anupam ARORA, Middletown, DE (US); Raj ARUMUGAM, Edison, NJ (US); John ROLLINS, Cocoa, FL (US); Roy THARPE, Merritt Island, FL (US); Venu NELLURI, Westborough, MA (US)

(21) Appl. No.: 18/179,826

(22) Filed: Mar. 7, 2023

(51) Int. Cl. G06N 20/00

(52) U.S. Cl. CPC G06N 20/00

(57) ABSTRACT

In some aspects, the techniques described herein relate to a method including: providing, on a model serving platform, a plurality of production machine learning models and a plurality of shadow machine learning models; routing input data to the plurality of production machine learning models and to the plurality of shadow machine learning models; receiving, at a model monitoring engine, production output data from a first production machine learning model of the plurality of production machine learning models; receiving, at the model monitoring engine, offline output data from a first shadow machine learning model of the plurality of shadow machine learning models; promoting the first shadow machine learning model to a production machine learning model based on the offline output data; and demoting the first production machine learning model based on the production output data.

### BACKGROUND

### 1. Field of The Invention

Aspects generally relate to systems and methods for machine learning model management.

### 2. Description of the Related Art

Testing of a machine learning (ML) model is a crucial step in the model's path to operation in a production environment. Model output must be collected and analyzed to determine that the output is falling within acceptable statistical and business ranges. Generally, newly trained, or retrained models are tested in an offline environment due to the risk of introducing an untested model into a production business environment. But offline testing is suboptimal because the data is often synthesized or stale. Additionally, the promotion timeline for a freshly trained model is lengthy and can contribute to models that lag behind current trends in the a model's field of operation.

### SUMMARY

In some aspects, the techniques described herein relate to a method including: providing, on a model serving platform, a plurality of production machine learning models and a plurality of shadow machine learning models; routing input data to the plurality of production machine learning models and to the plurality of shadow machine learning models; receiving, at a model monitoring engine, production output data from a first production machine learning model of the plurality of production machine learning models; receiving, at the model monitoring engine, offline output data from a first shadow machine learning model of the plurality of shadow machine learning models; promoting the first shadow machine learning model to a production machine learning model based on the offline output data; and demoting the first production machine learning model based on the production output data.

In some aspects, the techniques described herein relate to a method, including: providing an event streaming platform; routing the input data to the event streaming platform; and publishing the input data to a first topic.

In some aspects, the techniques described herein relate to a method, including: subscribing, by each of the plurality of shadow machine learning models, to the first topic, and consuming the input data from the event streaming platform.

In some aspects, the techniques described herein relate to a method, including: routing the production output data to the event streaming platform; and publishing the production output data to a second topic.

In some aspects, the techniques described herein relate to a method, including: routing the offline output data to the event streaming platform; and publishing the offline output data to a third topic.

In some aspects, the techniques described herein relate to a method, including: subscribing, by the model monitoring engine, to the second topic and the third topic.

In some aspects, the techniques described herein relate to a method, wherein each of the plurality of production machine learning models receives a different percentage of the input data.

In some aspects, the techniques described herein relate to a method, wherein each of plurality of shadow models receives 100% of the input data.

In some aspects, the techniques described herein relate to a method, including: providing a predetermined number of production slots and a predetermined number of shadow slots on the model serving platform, wherein each of the plurality of production machine learning models occupies one of the predetermined number of production slots, and wherein each of the plurality of shadow machine learning models occupies one of the predetermined number of shadow slots.

In some aspects, the techniques described herein relate to a method, wherein the first shadow machine learning model is upgraded to a one of the predetermined number of production slots previously occupied by the first production machine learning model.

In some aspects, the techniques described herein relate to a system including at least one computer including a processor, wherein the at least one computer is configured to: provide, on a model serving platform, a plurality of production machine learning models and a plurality of shadow machine learning models; route input data to the plurality of production machine learning models and to the plurality of shadow machine learning models; receive, at a model monitoring engine, production output data from a first production machine learning model of the plurality of production machine learning models; receive, at the model monitoring engine, offline output data from a first shadow machine learning model of the plurality of shadow machine learning models; promote the first shadow machine learning model to a production machine learning model based on the offline output data; and demote the first production machine learning model based on the production output data.

In some aspects, the techniques described herein relate to a system, wherein the at least one computer is configured to: provide an event streaming platform; route the input data to the event streaming platform; and publish the input data to a first topic.

In some aspects, the techniques described herein relate to a system, wherein each of the plurality of shadow machine learning models is configured to subscribe to the first topic, and consume the input data from the event streaming platform.

In some aspects, the techniques described herein relate to a system, wherein the at least one computer is configured to: route the production output data to the event streaming platform; and publish the production output data to a second topic.

In some aspects, the techniques described herein relate to a system, wherein the at least one computer is configured to: route the offline output data to the event streaming platform; and publish the offline output data to a third topic.

In some aspects, the techniques described herein relate to a system, wherein the model monitoring engine is configured to subscribe to the second topic and the third topic.

In some aspects, the techniques described herein relate to a system, wherein each of the plurality of production machine learning models is configured to receive a different percentage of the input data; and wherein each of plurality of shadow models is configured to receive 100% of the input data.

In some aspects, the techniques described herein relate to a system, wherein the at least one computer is configured to: provide a predetermined number of production slots and a predetermined number of shadow slots on the model serving platform, wherein each of the plurality of production machine learning models occupies one of the predetermined number of production slots, and wherein each of the plurality of shadow machine learning models occupies one of the predetermined number of shadow slots.

In some aspects, the techniques described herein relate to a system, wherein the first shadow machine learning model is upgraded to a one of the predetermined number of production slots previously occupied by the first production machine learning model.

In some aspects, the techniques described herein relate to a non-transitory computer readable storage medium, including instructions stored thereon, which instructions, when read and executed by one or more computer processors, cause the one or more computer processors to perform steps including: providing, on a model serving platform, a plurality of production machine learning models and a plurality of shadow machine learning models; routing input data to the plurality of production machine learning models and to the plurality of shadow machine learning models; receiving, at a model monitoring engine, production output data from a first production machine learning model of the plurality of production machine learning models; receiving, at the model monitoring engine, offline output data from a first shadow machine learning model of the plurality of shadow machine learning models; promoting the first shadow machine learning model to a production machine learning model based on the offline output data; and demoting the first production machine learning model based on the production output data.

### BRIEF DESCRIPTION OF THE DRAWINGS

FIG. 1 is a block diagram of a system for machine learning model management, in accordance with aspects.

FIG. 2 is a logical flow for machine learning model management, in accordance with aspects.

FIG. 3 is a block diagram of a computing device for implementing certain aspects of the present disclosure.

### DETAILED DESCRIPTION

Aspects generally relate to systems and methods for machine learning model management. Aspects may facilitate machine learning (ML) model/algorithm provisioning at a rapid pace and facilitate exposing the ML algorithm to production data loads and production data. Aspects may be provisioned to a cloud environment and may be cloud agnostic such that any cloud-computing platform may be used with the techniques described herein.

In accordance with aspects, shadow machine learning (ML) models may be tested in a production environment with production input data alongside production ML models. A shadow model may be exposed to production data concurrently, or in parallel, with production machine learning models. Model output can be evaluated to determine the quality of output a model (either a production model or a shadow model) is producing. Model output may be compared to determine which models are generating the most accurate or desirable output (e.g., the most accurate predictions with respect to the input data). Aspects also facilitate gauging model drift with respect to parallel models. Drift can be recognized and retraining of a drifting model can be initiated in a timely manner. Moreover, aspects facilitate rapid promotion of a model that is observed to be performing at more optimal levels than competing models. Shadow models may be promoted to production slots, and production models that are challenger models may be promoted to a champion model slot. Likewise, underperforming models may be demoted or decommissioned.

In accordance with aspects a model serving platform may allow for continuous retraining of a collection of models operating within the platform. Additionally, aspects facilitate serving of ML models completely within an organization's private cloud account and do not rely on managed services where data may be exposed, comingled, etc., with public data.

As used herein, the term “shadow model” is a model that executes in a model serving platform and that receives and processes input data from production applications (e.g., requests for predictions, inferences and other model output, including data parameters required by the models in order to produce the requested output), but whose output is not returned to the requesting production application. Rather, a shadow model's output is analyzed offline for performance, accuracy score assignment, etc. Performance may be analyzed with respect to various other models (either shadow models or production models) executing in the model serving platform. Decisions with respect to potential promotions or retraining of the model may be made based on the model's performance, including the model's accuracy scores and the model's ability to produce output within business-acceptable thresholds.

After models are trained (either initially or as a retraining exercise), the model must be tested. A model's accuracy, however, can best be gauged with current production data. Aspects allow freshly trained models to process current production data and generate output based thereon without introducing the risk involved with using the output of the newly trained model as production output. A newly trained or retrained model may be provisioned into a shadow model slot provided by a model serving platform, and the output may not be returned to the requesting client application.

When a production application makes a request to the platform, the request can be sent to one or more production models that can process the request and return a response to the requesting application. In addition, responses from the production model(s) may be sent to a monitoring engine. The request can also be sent in parallel to one or more shadow models. The shadow models may process the request and generate a response. The responses from one or more shadow models, however, may only be sent to the monitoring engine. The response from all responding models, whether production or shadow, may be analyzed at the model monitoring engine, and appropriate decisions with respect to models may be made based on the analytics provided by the monitoring engine.

Aspects may include an asynchronous event streaming platform that receives input data and publishes the input data to a topic which may be subscribed to. The event streaming platform may be configured to receive all incoming requests from client applications. Incoming requests from client applications may include all data parameters used by the models in producing the models' intended output (e.g., inferences, predictions, etc.). Incoming requests from production client computer applications may comprise input data to the model serving platform and the individual models executing thereon. Shadow models may be configured as consumers of the input data topic published by the event streaming platform. That is, each shadow model may subscribe to the topic and may receive each request sent to the topic. In this way, every shadow model may receive every production request as input data and may produce corresponding output for each request that may be analyzed. In this way, the shadow models may participate in an operational production environment while being tested.

In accordance with aspects, a model monitoring engine may evaluate the output of each model in an instance of a model serving platform and may determine how each model is performing/scoring. A model monitoring engine can assign decision scores to decisions made by each of the models and may aggregate and/or average decision scores to provide an overall model score. The scores may be used to determine upgrade paths, downgrade paths, and/or retraining paths for the models in a model serving platform instance. In some aspects, the scores or other analytics may be provided to a model governance team via, e.g., an interface such as a graphical user interface, and the model governance team may provide input with respect to model paths for upgrade, downgrade, retraining, decommissioning, etc.

In accordance with aspects, each model in a particular instance of a model serving platform may be configured and trained to service a particular business entity or business need. Instances of a model serving platform may be configured to execute on private and public cloud computing infrastructures and may be implemented in a container orchestration system as containerized applications. Container orchestration systems are widely available as a cluster management platform on public cloud platforms and, accordingly, lend themselves to cloud-agnostic implementation of the disclosed concepts. An exemplary container orchestration system is the Kubernetes container orchestration system. An instance of a model serving platform may execute within a logical environment, e.g., a namespace, of a container orchestration system. Within a given logical environment, all models may take similar input data and provide similar output data, so that relevant and informative comparisons can be made of the models' output with respect to each other.

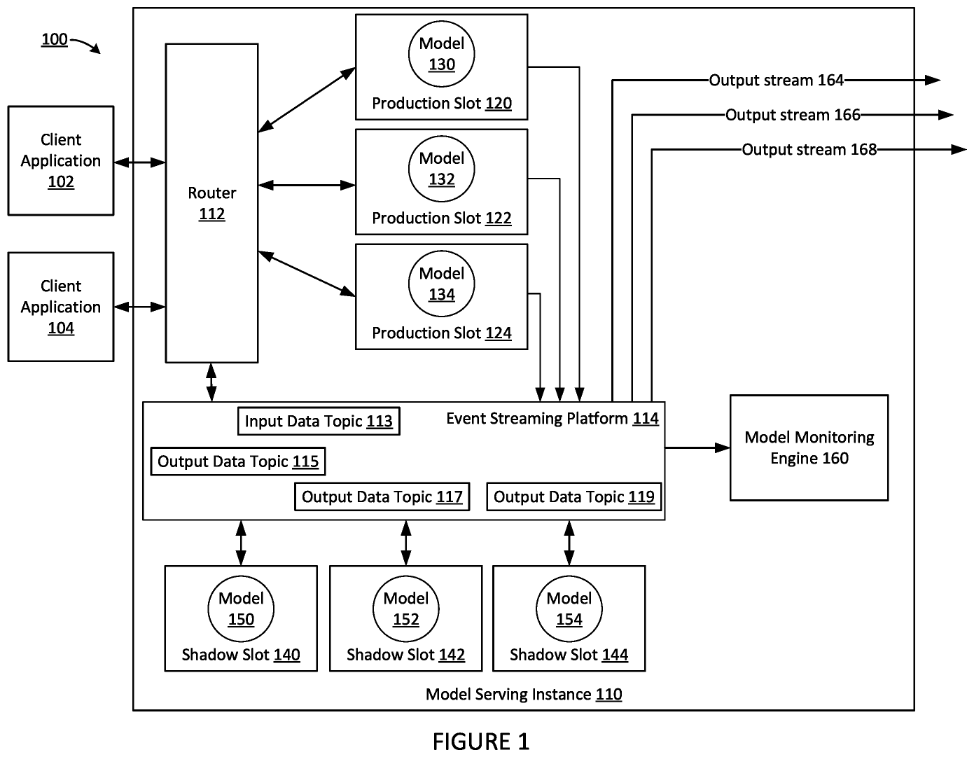

FIG. 1 is a block diagram of a system for machine learning model management, in accordance with aspects. System 100 includes model serving instance 110. Model serving instance 110 includes router 112, event streaming platform 114, and model monitoring engine 160. Model serving instance 110 also includes production slot 120, production slot 122, production slot 124, shadow slot 140, shadow slot 142, and shadow slot 144, each of which may be configured to house and execute a machine learning (ML) model. Depicted in each model slot of model serving instance 110 is a machine learning model. Production slot 120 houses and executes model 130, production slot 122 houses and executes model 132, and production slot 124 houses and executes model 134. Likewise, shadow slot 140 houses and executes model 150, shadow slot 142 houses and executes model 152, and shadow slot 144 houses and executes model 154.

With continued reference to FIG. 1, client application 102 and client application 104 are also shown. Further, output stream 164, output stream 166, and output stream 168 are depicted. While only two client applications and three out streams are shown in FIG. 1, this is an exemplary depiction and not meant to be limiting. It is contemplated that aspects may scale to include any necessary or desirable number of client applications or output streams for accessing a model service instance and its output.

In accordance with aspects, model serving instance 110 may be an instance of a model serving platform and may be executed on any appropriate platform. Exemplary platforms include public and private cloud computing environments. Model serving instance 110 may be implemented in a container orchestration system and components may be implemented as containerized applications. In an exemplary aspect, model serving instance 110 may be implemented on a public cloud, but entirely within a business unit's account to preserve the privacy of the data processed thereon.

In accordance with aspects, client application 102 and client application 104 may submit input data in the form of a request to router 112. Input data may request output from model serving instance 110 in the form of a prediction or inference. For example, if model serving instance 110 has been implemented by an organization that provides credit to individuals (e.g., credit cards, credit accounts, etc.), then client application 102 and/or client application 104 may submit requests for output in the form of a prediction with respect to credit risk of an individual, and models executing on model serving instance 110 may be trained to provide a prediction of an individual's credit worthiness as a measure of risk of default.

In another exemplary aspect of a business implementation of a model serving instance, a payment product issuer (e.g., an issuer of credit and/or debit cards) may provide payment card transaction details to model serving instance 110 and model serving instance 110 may provide a response that predicts the likelihood that the subject transaction is fraudulent.

In accordance with aspects, a model serving instance may expose a model serving instance via any suitable protocol and/or interface. Exemplary protocols/interfaces include API protocols/interfaces, event streaming protocols/interfaces, file ingestion protocols/interfaces, in-memory method invocation from within the client application, etc. A model serving instance may be configured to process single as well as batch request data on a single invocation.

In accordance with aspects, systems described herein may provide one or more application programming interfaces (APIs) in order to facilitate communication among components. APIs may publish various methods and expose the methods via API gateways. A published API method may be called by an application that is authorized to access the published API methods. API methods may take data as one or more parameters of the called method. API access may be governed by an API gateway associated with a corresponding API. Incoming API method calls may be routed to an API gateway and the API gateway may forward the method calls to internal API servers that may execute the called method, perform processing on any data received as parameters of the called method, and send a return communication to the method caller via the API gateway. A return communication may also include data based on the called method and its data parameters.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, gRPC, REST (Representational State Transfer), or the like.

With reference to FIG. 1, model serving instance 110 may expose model services via router 112 to client application 102 and client application 104. Router 112 may be configured with one or more protocols and interfaces for access by client applications. For instance, router 112 may be configured with an API gateway/interface and may publish API methods that client application 102 and/or client application 104 may call. The API methods may be parameterized with data from client application 102 and/or client application 104 that model serving instance 110 and its ML models require to produce the requested output. In another aspect, router 112 may be configured as an event streaming platform. In another aspect, router 112 may be configured to accept files in various formats (e.g., comma separated value (CSV)) for ingestion as input data. Router 112 may be configured to accept any suitable input data format.

Once received, router 112 may forward the input data to ML models executing on model serving instance 110 for processing. Input data may be sent to production models according to flow logic. For instance, flow logic may determine a percentage of input data to direct to each production model. Production models may be configured in a champion challenger model where, at a point in time, the champion model is determined to be the optimal model, and challenger models may be less optimal, but still provide output within acceptable statistical and business thresholds or windows. In accordance with aspects, a champion model may be configured to receive a majority of input data (e.g., 75% of input data), while a first challenger is configured to receive a lesser amount (e.g., 20% of input data), and a second challenger is configured to receive an even lesser amount (e.g., the remaining 5% of input data).

A model serving instance may provide production slots for executing production models. Each production slot may include an identifier, and an input data router may be configured to send different amounts of input data to the ML models in each slot. The amount or percentage of input data sent to a particular slot may be determined by analytics executed on the output from each model. By analyzing model output, a champion model may be designated as a most optimal model, and a relatively larger amount of production input data may be sent to the corresponding slot housing the champion production model for processing by the champion production model.

With reference, again, to FIG. 1, production slot 120, production slot 122, and production slot 124 are provided. While only 3 production model slots are depicted, it is contemplated that a model serving platform/instance may scale to provide any necessary or desirable number of production model slots. In accordance with aspects, production slot 120 houses and executes model 130, production slot 122 houses and executes model 132, and production slot 124 houses and executes model 134. Output from each model may be communicated to model monitoring engine 160, and model monitoring engine 160 may perform analytics on the output received from the production models. Based on the analytics performed on the out from model 130, model 132, and model 134, model monitoring engine 160 may determine that model 130 is a champion model and router 112 may be configured to send a relatively higher amount of production data (e.g., a majority of production data) to production slot 120 for processing by model 130.

In accordance with aspects, client applications, such as business applications, may receive output from production models. Client applications may receive production model output in any suitable manner. For instance, a client application may receive production model output via a return payload form an API method call, as a consumer of a data stream provided by an event streaming platform, etc.

In addition to production models, a model serving instance may communicate production input data to shadow models. With continuing reference to FIG. 1, router 112 may be configured to communicate production input data to an event streaming platform as a producer for the event streaming platform. Router 112 may be configured to communicate 100% of received production input data to an event streaming platform. The event streaming platform may publish a topic that provides the received production input data for consumption by subscribers to the topic. Shadow model slots provided by the model serving instance may subscribe to the topic and models housed therein may process the received input data asynchronously as it is received from the topic.

A distributed event streaming platform (e.g., Apache Kafka®) may be implemented as part of a model serving platform/instance for handling of received production input data events in the form of real time and near-real time streaming data to/from streaming data pipelines and/or streaming applications (e.g., a client applications). Streaming data is data that is continuously generated by a data source. An event streaming platform can receive streaming data from multiple sources and process the data sequentially and incrementally. Event streaming platforms can be used in conjunction with real time and near-real time streaming data pipelines and streaming applications. For example, an event streaming platform can ingest and store streaming data from the data pipeline or application and provide the data to an application that processes the streaming data. An event streaming platform may include partitioned commit logs (each, an ordered sequence of records) to store corresponding streams of records. The logs are divided into partitions, and a subscriber can subscribe to a “topic” that is associated with a partition, and thereby receive all records stored at the partition (e.g., as passed to the subscriber in real time by the platform).

An event streaming platform may expose a producer API that publishes a stream of records to a topic, and a consumer API that a consumer application can use to subscribe to topics and thereby receive the record stream associated with that topic. An event streaming platform may also publish other APIs with necessary or desired functionality. An event streaming platform allows for asynchronous processing, since a producer does not have to wait for a response form a consumer before sending additional data to the topic.

Referring to FIG. 1, router 112 may be configured as a producer for input data topic 113 published by event streaming platform 114. In addition to sending production input data to production models, router 112 may send received production data to event streaming platform 114 and event streaming platform 114 may publish the received input data to input data topic 113. Shadow slot 140, shadow slot 142, and shadow slot 144 may each subscribe to input data topic 113 and may consume all data sent to input data topic 113. In this way, each shadow slot may receive and process all production data received at model serving instance 110.

In addition to publishing an input data topic, event streaming platform 114 may be configured to publish an output data topic for each shadow slot, and each shadow slot may be configured as a producer that sends all model output to its corresponding output data topic. As shown in FIG. 1, event streaming platform 114 may publish output data topic 115, and shadow slot 140 may be configured as a producer to, and send all output from model 150 to, output data topic 115. In the same way, shadow slot 142 may send output data from model 152 to output data topic 117, and shadow slot 144 send output data from model 154 to output data topic 119.

In accordance with aspects, model monitoring engine 160 may subscribe to each of output data topic 115, output data topic 117, and output data topic 119. Model monitoring engine 160, as a subscriber of each output data topic, may receive all output data from each shadow model in each shadow slot. Model monitoring engine 160 may then perform analytics on the output data from each shadow model.

In accordance with aspects, newly trained/retrained models may be deployed to shadow model slots for initial testing and evaluation by a model monitoring engine. As a model monitoring engine evaluates output from a shadow model, a determination may be made as to promotions, retraining, and/or decommissioning paths for shadow models. While output data generated by models in a production slot may be returned to the requesting client application, output from models in a shadow slot may only be accessible to a model monitoring engine. Accordingly, shadow models may participate in processing current production input data, while output data generated by the models may be kept offline with respect to client applications until the shadow model scores well enough to be promoted to a production model.

With reference to FIG. 1, production slot 120, production slot 122, and production slot 124 may also publish output data to corresponding output topics (not shown) of event streaming platform 114. Model monitoring engine 160 may also subscribe to these output data topics. In this manner, model monitoring engine 160 may receive all output data from each model in each model slot of model serving instance 110. Model monitoring engine 160 may perform analytics on the output data of all models executing in model serving instance 110 and may provide model scores or other decisioning criteria based on an evaluation of performed analytics and acceptable statistical and business thresholds for data output.

Model monitoring engine 160 may be configured to detect model drift, and if drift is detected on a production model, a decision can be made to demote the model. In some instances, and based on a degree of determined drift, if the drifting model is the champion model, a demotion may be indicated for the current champion. In this case, a challenger model may be slated for upgrade to the new champion model based on model scores or other performance indicators. In some cases, evaluation by a model monitoring engine may indicate that a production model may be decommissioned, and a shadow model will be upgraded to a production model to replace the decommissioned production model. In accordance with aspects, any appropriate promotions, demotions and/or decommissioning of models executing in a model serving instance may be decisioned based on a model monitoring engine's analytical processing and evaluation of the models' output in a comparative environment. Champion models may be demoted to a challenger slot or a shadow slot or may be decommissioned. Challenger models may be promoted to a higher order challenger slot or to the champion slot or may be demoted to a shadow slot or decommissioned. Shadow models may be promoted to a production slot as a challenger or a champion or may be decommissioned.

In accordance with aspects, any downstream application may also subscribe to output streams of output data provided by an event streaming platform. With reference to FIG. 1, output stream 164, output stream 166, and output stream 168 are depicted as streaming output data to various downstream applications (not shown) that may benefit from the output data. Exemplary downstream applications and/or platforms that may subscribe to output streams include model training environments, model management systems and interfaces, artificial intelligence (AI) governance and control platforms, Line-of-business (LOB) model evaluation services, LOB analysis interfaces/data warehouses etc.

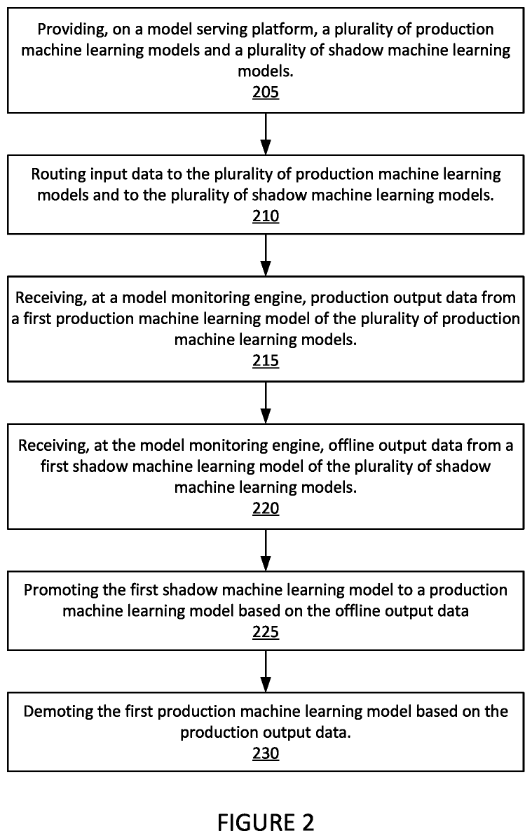

FIG. 2 is a logical flow for machine learning model management, in accordance with aspects.

Step 205 includes providing, on a model serving platform, a plurality of production machine learning models and a plurality of shadow machine learning models.

Step 210 includes routing input data to the plurality of production machine learning models and to the plurality of shadow machine learning models. In accordance with aspects, an event streaming platform may be provided, and the input data may be routed to the event streaming platform. The event streaming platform may publish the input data to a first topic. Each of the plurality of shadow machine learning models, may subscribe to the first topic, and consume the input data from the event streaming platform's first topic. Each of the production machine learning models may receive a different percentage of the input data. Each of plurality of shadow models may receive 100% of the input data.

Step 215 includes receiving, at a model monitoring engine, production output data from a first production machine learning model of the plurality of production machine learning models. The production output data may be routed to the event streaming platform and the production output data may be published to a second topic which the model monitoring engine subscribes to.

Step 220 includes receiving, at the model monitoring engine, offline output data from a first shadow machine learning model of the plurality of shadow machine learning models. The offline output data may also be routed to the event streaming platform and the offline output data may be published to a third topic which the model monitoring engine subscribes to.

Step 225 includes promoting the first shadow machine learning model to a production machine learning model based on the offline output data; and

Step 230 includes demoting the first production machine learning model based on the production output data.

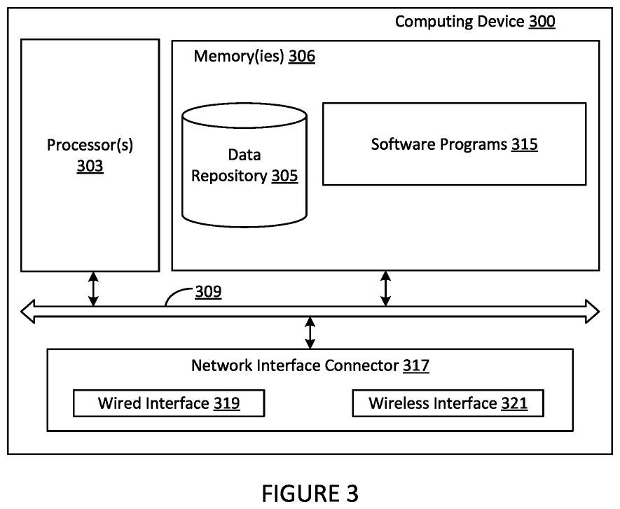

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as client applications, an input date router (e.g., router 112), machine learning slots, an event streaming platform a model monitoring engine, various database engines and database servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a micro-processor and/or in the form of statically or dynamically programmed electronic circuitry.

The system of the invention or portions of the system of the invention may be in the form of a “processing machine” a “computing device,” or an “electronic device” etc. These may be a general-purpose computer, a computer server, a host machine, etc. As used herein, the term “processing machine,” “computing device,” “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software. In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
providing, on a model serving platform, a plurality of production machine learning models and a plurality of shadow machine learning models;
routing input data to the plurality of production machine learning models and to the plurality of shadow machine learning models;
receiving, at a model monitoring engine, production output data from a first production machine learning model of the plurality of production machine learning models;
receiving, at the model monitoring engine, offline output data from a first shadow machine learning model of the plurality of shadow machine learning models;
promoting the first shadow machine learning model to a production machine learning model based on the offline output data; and
demoting the first production machine learning model based on the production output data.

2. The method of claim 1, comprising:
providing an event streaming platform;
routing the input data to the event streaming platform; and
publishing the input data to a first topic.

3. The method of claim 2, comprising:
subscribing, by each of the plurality of shadow machine learning models, to the first topic, and consuming the input data from the event streaming platform.

4. The method of claim 2, comprising:
routing the production output data to the event streaming platform; and
publishing the production output data to a second topic.

5. The method of claim 4, comprising:
routing the offline output data to the event streaming platform; and
publishing the offline output data to a third topic.

6. The method of claim 5, comprising:
subscribing, by the model monitoring engine, to the second topic and the third topic.

7. The method of claim 1, wherein each of the plurality of production machine learning models receives a different percentage of the input data.

8. The method of claim 7, wherein each of plurality of shadow models receives 100% of the input data.

9. The method of claim 1, comprising:
providing a predetermined number of production slots and a predetermined number of shadow slots on the model serving platform, wherein each of the plurality of production machine learning models occupies one of the predetermined number of production slots, and wherein each of the plurality of shadow machine learning models occupies one of the predetermined number of shadow slots.

10. The method of claim 9, wherein the first shadow machine learning model is upgraded to a one of the predetermined number of production slots previously occupied by the first production machine learning model.

11. A system comprising at least one computer including a processor, wherein the at least one computer is configured to:
provide, on a model serving platform, a plurality of production machine learning models and a plurality of shadow machine learning models;
route input data to the plurality of production machine learning models and to the plurality of shadow machine learning models;
receive, at a model monitoring engine, production output data from a first production machine learning model of the plurality of production machine learning models;
receive, at the model monitoring engine, offline output data from a first shadow machine learning model of the plurality of shadow machine learning models;
promote the first shadow machine learning model to a production machine learning model based on the offline output data; and
demote the first production machine learning model based on the production output data.

12. The system of claim 11, wherein the at least one computer is configured to:
provide an event streaming platform;
route the input data to the event streaming platform; and
publish the input data to a first topic.

13. The system of claim 12, wherein each of the plurality of shadow machine learning models is configured to subscribe to the first topic, and consume the input data from the event streaming platform.

14. The system of claim 12, wherein the at least one computer is configured to:
route the production output data to the event streaming platform; and
publish the production output data to a second topic.

15. The system of claim 14, wherein the at least one computer is configured to:
route the offline output data to the event streaming platform; and
publish the offline output data to a third topic.

16. The system of claim 15, wherein the model monitoring engine is configured to subscribe to the second topic and the third topic.

17. The system of claim 11, wherein each of the plurality of production machine learning models is configured to receive a different percentage of the input data; and
wherein each of plurality of shadow models is configured to receive 100% of the input data.

18. The system of claim 11, wherein the at least one computer is configured to:
provide a predetermined number of production slots and a predetermined number of shadow slots on the model serving platform, wherein each of the plurality of production machine learning models occupies one of the predetermined number of production slots, and wherein each of the plurality of shadow machine learning models occupies one of the predetermined number of shadow slots.

19. The system of claim 18, wherein the first shadow machine learning model is upgraded to a one of the predetermined number of production slots previously occupied by the first production machine learning model.

20. A non-transitory computer readable storage medium, including instructions stored thereon, which instructions, when read and executed by one or more computer processors, cause the one or more computer processors to perform steps comprising:
providing, on a model serving platform, a plurality of production machine learning models and a plurality of shadow machine learning models;
routing input data to the plurality of production machine learning models and to the plurality of shadow machine learning models;
receiving, at a model monitoring engine, production output data from a first production machine learning model of the plurality of production machine learning models;
receiving, at the model monitoring engine, offline output data from a first shadow machine learning model of the plurality of shadow machine learning models;
promoting the first shadow machine learning model to a production machine learning model based on the offline output data; and
demoting the first production machine learning model based on the production output data.
